(19) United States
(12) Patent Application Publication
(10) Pub. No.: US 2026/0278231 A1
(43) Pub. Date: Sep. 17, 2026

(54) Early-Stage Integrated Circuit Electrostatic Discharge Safeguarding

(71) Applicant: Google LLC, Mountain View, CA (US)

(72) Inventors: Vaibhav Gupta, Bangalore (IN); Sandeep Nachireddy, Bangalore (IN)

(73) Assignee: Google LLC, Mountain View, CA (US)

(21) Appl. No.: 19/668,927

(22) Filed: May 6, 2026

Related U.S. Application Data
(60) Provisional application No. 63/960,194, filed on Jan. 14, 2026.

(51) Int. Cl. G06F 30/367; G06F 30/398; G06F 111/10; G06F 119/02

(52) U.S. Cl. CPC G06F 30/367; G06F 30/398; G06F 2111/10; G06F 2119/02

(57) ABSTRACT

The present disclosure describes techniques and apparatuses that are directed to integrated circuit design and fabrication. Designers may, for example, apply the techniques to identify failing Electrostatic Discharge (ESD) clamps at a floor planning stage, rather than waiting for signoff. These techniques, including a new flow process, may successfully identify violations missed by traditional flow processes, and may identify such violations earlier in the overall design and fabrication process.

### CROSS-REFERENCE TO RELATED APPLICATION

This application claims the benefit of U.S. Provisional Patent Application Ser. No. 63/960,194, filed on Jan. 14, 2026, the disclosure of which is incorporated by reference herein in its entirety.

### BACKGROUND

Electrostatic Discharge (ESD) is a sudden flow of electricity between two electrically charged objects caused by contact, an electrical short, or dielectric breakdown. In the context of integrated circuits (ICs), ESD events (such as a person touching a chip after accumulating static charge) can destroy internal functional components. To mitigate this damage, designers integrate ESD protection circuits, commonly referred to as “ESD clamps,” which divert high-current pulses away from sensitive circuitry.

### SUMMARY

This document describes techniques and apparatuses, implemented in integrated circuit design systems, directed at Early-Stage Integrated Circuit Electrostatic Discharge Safeguarding. These techniques and apparatuses enable accurate and efficient verification of electrostatic discharge protection circuits early in a design cycle by modeling internal structures down to the lowest metal layers, providing timely detection of robustness issues without requiring a short-clean design database.

In general, a first aspect of the present disclosure relates to a method for Early-Stage Integrated Circuit Electrostatic Discharge Safeguarding. The method includes receiving a layout of an integrated circuit design during an early design phase. The layout includes at least one electrostatic discharge (ESD) protection circuit and is not required to be short-clean. The method further includes configuring a grid-based extraction tool to model an internal structure of the at least one ESD protection circuit from a top metal layer down to a lowest metal layer. The method also includes modeling layers of the integrated circuit design by modeling the internal structure of the at least one ESD protection circuit while excluding unrelated power grid geometries that do not impact ESD analysis. Additionally, the method includes analyzing resistance and current density of the at least one ESD protection circuit using the configured grid-based extraction tool to identify violations within the internal structure. The method further includes generating a verification report indicating whether the at least one ESD protection circuit meets a robustness threshold defined for the lowest metal layer.

In general, a second aspect of the present disclosure relates to an apparatus for Early-Stage Integrated Circuit Electrostatic Discharge Safeguarding. The apparatus includes a memory storing a layout of an integrated circuit design. The layout includes at least one ESD protection circuit. The apparatus also includes a processor coupled to the memory and configured to execute a grid-based extraction tool. The processor executes the grid-based extraction tool to model an internal structure of the at least one ESD protection circuit from a top metal layer down to a lowest metal layer during an early design phase. The layout of the integrated circuit design is not required to be short-clean. The processor also executes the grid-based extraction tool to extract geometries by including layers of the internal structure of the at least one ESD protection circuit and excluding unrelated power grid geometries. Furthermore, the processor executes the grid-based extraction tool to calculate resistance and current density through the internal structure of the at least one ESD protection circuit. The processor also executes the grid-based extraction tool to verify the at least one ESD protection circuit against a robustness threshold associated with the lowest metal layer.

This document also describes computer-readable media having instructions for performing the above-summarized method and other methods set forth herein, as well as systems and means for performing these methods.

This Summary is provided to introduce simplified concepts for Early-Stage Integrated Circuit Electrostatic Discharge Safeguarding, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

Apparatuses and techniques that fabricate and use ESD protection are described with reference to the following drawings. The same numbers are used throughout the drawings to reference like features and components:

FIG. 1 is a schematic cross-sectional view of an integrated circuit in accordance with certain conventional implementations in which ESD testing and verification may be problematic.

FIG. 2 is a schematic cross-sectional view of an integrated circuit in accordance with certain example aspects of the present description, in which ESD testing and verification may be less problematic, e.g., in comparison to the FIG. 1 example.

FIG. 3A is bar graph illustrating violations caught in example conventional Plan of Record (POR) flow testing and verification process designs, e.g., as illustrated in FIG. 1, where only 30 failures were detected.

FIG. 3B is bar graph illustrating violations caught in example flow testing and verification process designs in accordance with certain aspects of the present description, e.g., as illustrated in FIG. 2, where 70 failures were detected.

FIG. 4 is a flow-diagram illustrating an example flow process, in accordance with certain examples.

FIG. 5 is a schematic block diagram illustrating an example apparatus, in accordance with certain examples.

### DETAILED DESCRIPTION

Verifying the robustness of ESD clamps is often a key step in a design cycle. Current industry's standard methodologies typically split this verification into two distinct phases. Early in the design cycle (e.g., during floor planning), designers may utilize resistance and current density checks that may only analyze the path from the chip interface (bumps) to the upper metal pins of the ESD clamp, for example, Metal 13 (M13). This approach tends to treat the internal structure of the clamp as a “black box,” leaving the designer unaware of any potential resistance or current density violations occurring within the clamp structure itself (e.g., from M13 down to Metal 0 or M0).

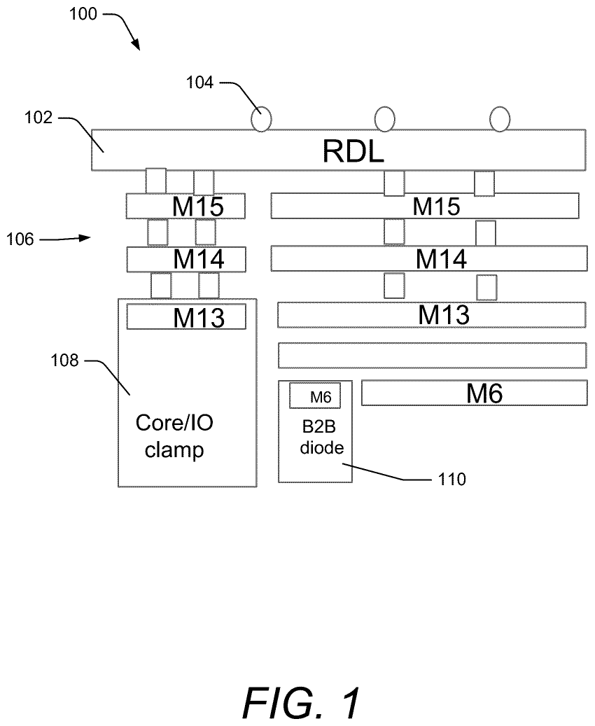

Attention is drawn, for example, to FIG. 1, which illustrates a cross-sectional view of a portion of an integrated circuit 100 having an RDL 102 with bumps 104 on one side and various metal layers 106, an example ESD108, and a B2B diode 110 formed on the other side.

By way of further example, with current integrated circuit design flows, ESD verification may be split into two phases: (1.) Early-Stage Checks (Floor Planning): During a floor planning (FP) stage, tools like PathFinder-SC from Ansys may, for example, be used to perform resistance and Current Density (CD) checks. However, these checks are typically limited to the path from the Redistribution Layer (RDL) bumps to the top metal pins of the ESD structures (e.g., Metal 13 or “M13”). As such, the ESD clamp's internal connectivity down to the substrate may not be considered; and (2.) Final Signoff: Comprehensive ESD closure using signoff tools (e.g., PERC) may occur at or near an end of the design cycle (“Base Tape-Out” or BTO). This may, for example, be caused as such tools generally require the design database (DB) to be “short clean” (free of electrical shorts), a state that is only achieved late in the process. While some Design Exchange Format (DEF) based solutions exist and are used across the industry, such solutions are typically limited to checking only up to the higher pin layers of the clamp, leaving designers unaware of issues deeper inside the clamp structure. Furthermore, final ESD signoff analysis can be very cumbersome from a resource and runtime point of view. Because signoff tools (which are often GDS-based) typically require importing all geometries in the entire design, the computational load and time required for analysis during the end phase of the design are significantly increased.

Hence, current methodology presents several potential risks and possible inefficiencies. For example, there may be a late detection of risks, because the early checks may stop at the top metal pins (M13), designers may remain unaware of potential robustness issues inside an ESD clamp until the end of the design cycle. There may be undefined thresholds, e.g., foundries typically define PASS/FAIL thresholds for the device level (M0), not for intermediate metal layers like M13. This can make it difficult to accurately judge pass/fail status during early checks. There may be a tool miscorrelation, e.g., there is often a miscorrelation between the results of early-stage tools (PathFinder-SC) and final signoff tools (PERC), which may lead to a false confidence. Further, there may be schedule risks, e.g., in relying on final signoff means that violations found close to tape-out may cause schedule delays.

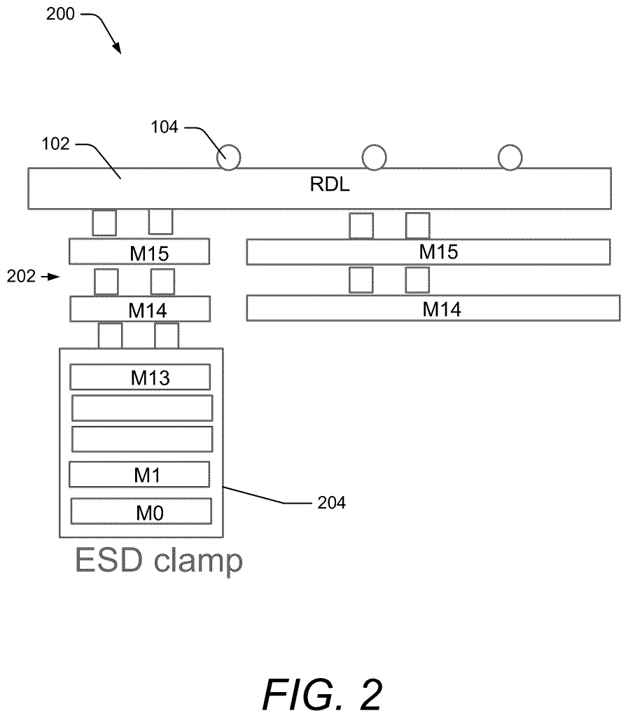

Attention is drawn, for example, to FIG. 2, which illustrates a cross-sectional view of a portion of an integrated circuit 200 having an RDL 102 with bumps 104 on one side and various metal layers 202, and an example ESD 204, formed on the other side, in accordance with certain example implementations of the present description.

The present description presents example techniques that may enable accurate ESD verification early in a design cycle, for example, at a floor planning stage.

In accordance with certain example implementations, techniques are presented to model ESD clamps possibly down to a lower metal layer (Metal 0 or M0), e.g., using GDSII-to-SC (gds2sc) extraction or the like, rather than stopping at the top pins.

To maintain efficiency and create a lightweight database, example techniques herein may include modeling the clamp internals down to M0 while removing or abstracting layers (e.g., down to M13), e.g., outside the clamp areas, e.g., as illustrated in ESC clamp 204. In particular, creating this lightweight database may include removing unrelated power grid (PG) geometries in the design that do not materially impact the ESD clamp analysis. Filtering out these non-essential components makes the extraction and analysis accurate as well as significantly quicker than the current signoff strategies utilized during the end phase of the design.

By modeling down to M0, designers may, for example, directly apply a foundry-provided PASS/FAIL thresholds or the like, which may reduce ambiguity or otherwise improve failure detections when compared to conventional techniques, e.g., as shown in FIG. 1. For instance, specific constraints and pass/fail thresholds provided by a foundry, such as TSMC, to meet clamp requirements can be directly applied to the lower-level measurements without ambiguity.

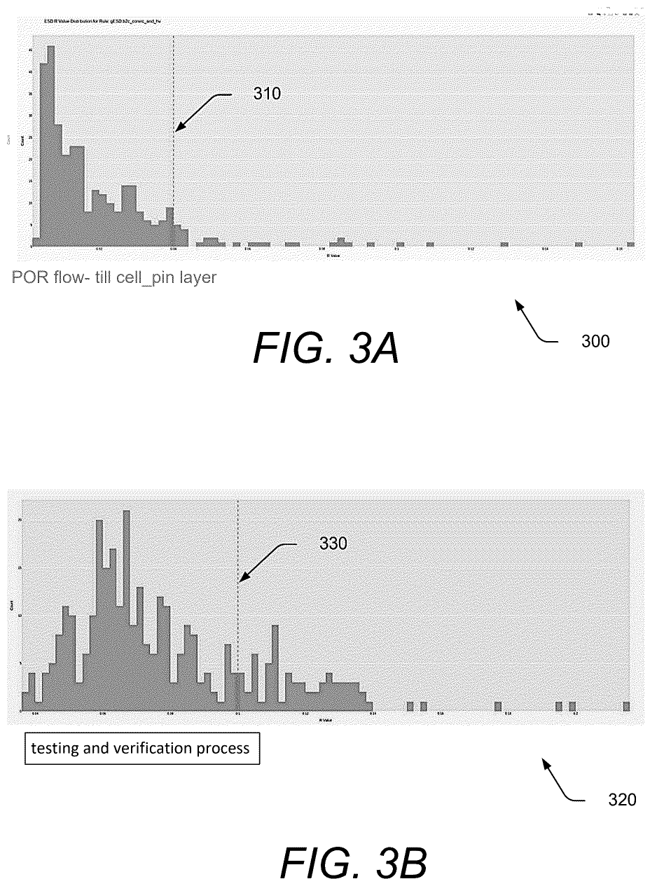

The techniques described here may be enabled at various stages of the design, including rough floor planning. For example, implementing these checks at an M4FP (floor planning) stage allows designers to understand which clamps are marginally failing early in the development cycle. This early detection provides headroom for Technical Design Integration (TDI) or other engineering teams to seek design waivers in cases where no further physical fixes to the layout are possible. Designers may identify failing clamps at the floor planning stage, rather than waiting for signoff. In certain instances, it is believed that the techniques (e.g., with M0 flow) may successfully identify violations (e.g., 70 failures vs. 30 in the POR flow) that were missed by the traditional Plan of Record (POR) flow but would have eventually been flagged by final signoff tools. For example, see FIG. 3A and FIG. 3B. Furthermore, correlation exercises comparing this early-stage verification flow with final signoff tools have demonstrated that the early-stage verification results correlate within approximately 10% of the final signoff tool results. This high degree of correlation provides engineers with early confidence in the ESD robustness of the design prior to achieving a short-clean database.

A conventional flow (e.g., see FIG. 1) may check connectivity from bumps 104 through upper metal layers 106 (e.g., M15, M14) only down to M13 (e.g., ESD 108 pins) or M6 of Back-to-Back (B2B) diode pins.

In contrast, the example flow illustrated in FIG. 2 may extend modeling inside the ESD clamp through the entire stack (M13, M1, M0), enabling Bump-to-Clamp, Current Density (CD) checks, or the like, on the complete protection path, e.g., from M0 of ESD clamp 204 though metal layer 202, circuit elements of RDL 102 to one or more bumps 104.

FIG. 3A is bar graph 300 illustrating violations caught in example conventional POR flow testing and verification process designs, e.g., as illustrated in FIG. 1 at a late stage such as Base Tape Out stage when a design is short-clean. The y-axis represents a count of failures and the x-axis represents an R-value (range). Line 310 marks the failure detection at 30 failures in this example.

FIG. 3B is bar graph 320 (similar to bar graph 300) illustrating violations caught in example flow testing and verification process designs in accordance with certain aspects of the present description, e.g., as illustrated in FIG. 2 at early stage such as a Floorplan stage. In this example, 70 failures were detected as shown at line 330. Hence, failure detection may be improved in certain instances by applying the techniques presented herein.

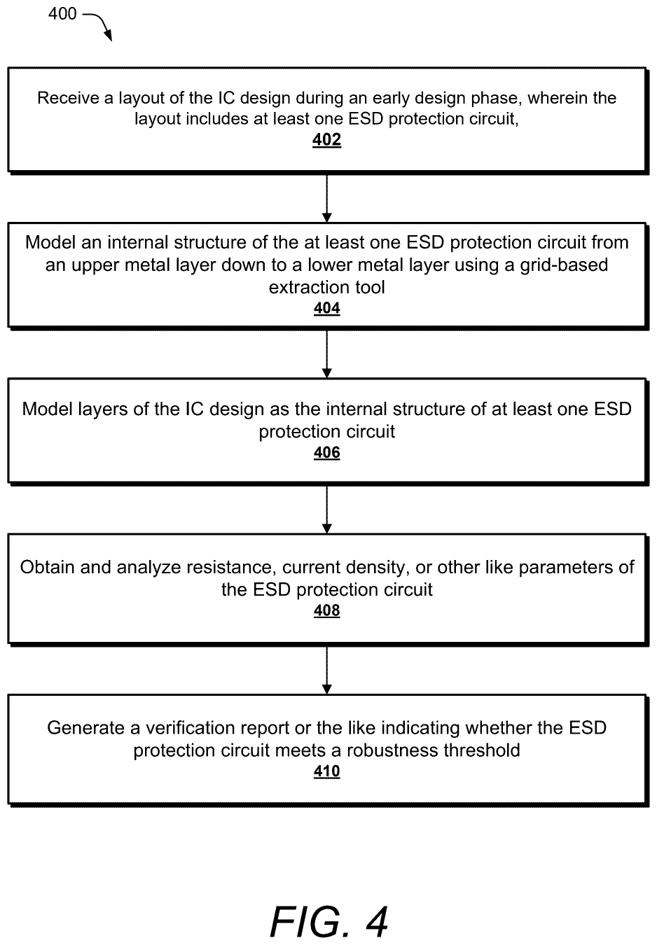

Attention is drawn next to FIG. 4, which illustrates a method 400 for verifying ESD protection in an IC design, in accordance with certain example implementations.

In example action 402, a layout of the IC design may be received during an early design phase, wherein the layout includes at least one ESD protection circuit, and the layout is not required to be short-clean.

In example action 404, a grid-based extraction tool may be configured to model an internal structure of the at least one ESD protection circuit from a top metal layer down to a lower metal layer. In certain example implementations, a top metal layer may represent an upper (most) metal layer. In certain example implementations, a lower metal layer may represent a lowest metal layer.

In example action 406, layers of the integrated circuit design may be modeled as the internal structure of at least one ESD protection circuit while excluding unrelated power grid geometries that do not impact ESD analysis.

In example action 408, resistance, current density, or other like parameters, of the ESD protection circuit may be analyzed, e.g., using the configured grid-based extraction tool to identify violations within the internal structure.

In example action 410, a verification report or the like may be generated indicating whether the ESD protection circuit meets a robustness threshold defined for the lower metal layer.

In certain example implementations: the early design phase may comprise a floor planning stage of the IC design; the lower metal layer may comprise a Metal 0 (M0) layer and the top metal layer may comprise a Metal 13 (M13) or Metal 14 (M14) layer; the robustness threshold defined for the lower metal layer may be provided by a foundry; the grid-based extraction tool may comprise a PathFinder-SC tool, or other like tool; or modeling layers may comprise increasing modeling accuracy for layers within the at least one ESD protection circuit while reducing modeling of intermediate layers outside the at least one ESD protection circuit. e.g., to improve tool performance.

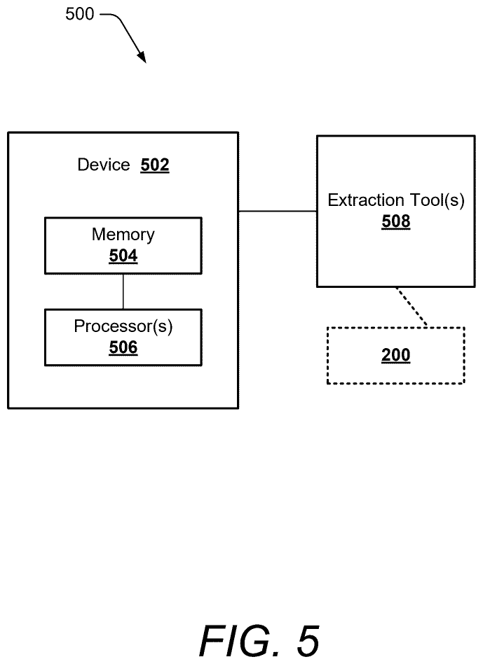

In certain instances, all or part of method 400 may be configured using all or part of the example apparatus of FIG. 5.

Attention is drawn next to FIG. 5, where an example apparatus 500 is shown for use in verifying ESD protection in an IC design, in accordance with certain aspects the present description. Apparatus 500 may comprise one or more devices 502, comprising memory 504 and one or more processors 506, as well as appliable test extraction devices 508 and the like. In certain instances, all or part of apparatus 500 may be configured to perform all or part of the example method of FIG. 4.

By way of an example, a memory may be provided for storing a layout of the IC design, where the layout includes at least one ESD protection circuit. A processor or multiple processors may be coupled to the memory and configured to execute a grid-based extraction tool. The grid-based extraction tool may model an internal structure of the at least one ESD protection circuit from a top metal layer down to a lower metal layer during an early design phase. The grid-based extraction tool may extract geometries by including layers of the internal structure of the at least one ESD protection circuit (possibly excluding unrelated power grid geometries), and calculate resistance, current density, or other like parameters, e.g., through the internal structure of the at least one ESD protection circuit. The grid-based extraction tool may, for example, be used to verify an ESD protection circuit against a robustness threshold associated with the lower metal layer.

In the following, various example implementations are described:

Example 1 is a method for verifying electrostatic discharge (ESD) protection in an integrated circuit design and may include: receiving a layout of the integrated circuit design during an early design phase, the layout including at least one ESD protection circuit and not being required to be short-clean; configuring a grid-based extraction tool to model an internal structure of the at least one ESD protection circuit from an upper metal layer down to a lower metal layer; modeling layers of the integrated circuit design by modeling the internal structure of the at least one ESD protection circuit while excluding unrelated power grid geometries that do not impact ESD analysis; analyzing a resistance, a current density, or both of the at least one ESD protection circuit using the configured grid-based extraction tool to identify violations within the internal structure; and generating a verification report indicating whether the at least one ESD protection circuit meets a robustness threshold defined for the lower metal layer.

Example 2 is a method of example 1 or other example methods, wherein the early design phase comprises a floor planning stage of the integrated circuit design.

Example 3 is a method of example 1 or other example methods, wherein the lower metal layer comprises a lowest metal layer.

Example 4 is a method of example 1 or other example methods, wherein the lower metal layer comprises a Metal 0 (M0) layer.

Example 5 is a method of example 1 or other example methods, wherein the upper metal layer comprises a top metal layer.

Example 6 is a method of example 1 or other example methods, wherein the upper metal layer comprises a Metal 13 (M13) or a Metal 14 (M14) layer.

Example 7 is a method of example 1 or other example methods, wherein the robustness threshold defined for the lower metal layer is provided by a foundry.

Example 8 is a method of example 1 or other example methods, wherein the grid-based extraction tool comprises a PathFinder-SC tool from Ansys.

Example 9 is a method of example 1 or other example methods, wherein selectively modeling layers comprises increasing modeling accuracy for layers within the at least one ESD protection circuit while reducing modeling of intermediate layers outside the at least one ESD protection circuit.

Example 10 is an apparatus for verifying electrostatic discharge (ESD) protection in an integrated circuit (IC) design, the apparatus may include: a memory storing a layout of the integrated circuit design, the layout including at least one ESD protection circuit; and a processor coupled to the memory and configured to execute a grid-based extraction tool configured to: model an internal structure of the at least one ESD protection circuit from an upper metal layer down to a lower metal layer during an early design phase, the layout of the IC design not required to be short-clean; extract geometries by including layers of the internal structure of the at least one ESD protection circuit and excluding unrelated power grid geometries; calculate resistance and current density through the internal structure of the at least one ESD protection circuit; and verify the at least one ESD protection circuit against a robustness threshold associated with the lower metal layer.

Example 11 is an apparatus of example 10 or other example apparatuses, wherein the grid-based extraction tool is configured to perform analysis on the layout during a floor planning stage.

Example 12 is an apparatus of example 10 or other example apparatuses, wherein the processor is configured to model the internal structure from a top pin layer down to a substrate-level metal layer.

Example 13 is an apparatus of example 10 or other example apparatuses, wherein the lower metal layer comprises a lowest metal layer.

Example 14 is an apparatus of example 10 or other example apparatuses, wherein the lower metal layer comprises a Metal 0 (M0) layer.

Example 15 is an apparatus of example 10 or other example apparatuses, wherein the upper metal layer comprises a top metal layer.

Example 16 is an apparatus of example 10 or other example apparatuses, wherein the upper metal layer comprises a Metal 13 (M13) or a Metal 14 (M14) layer.

Example 17 is an apparatus of example 10 or other example apparatuses, wherein the robustness threshold is a foundry-provided threshold.

Example 18 is an apparatus of example 10 or other example apparatuses, wherein the robustness threshold is for a Metal 0 (M0) layer.

Example 19 is an apparatus of example 10 or other example apparatuses, wherein the processor is configured to abstract unrelated nets to reduce computational load on the grid-based extraction tool.

Example 20 is an apparatus of example 10 or other example apparatuses, wherein the verification of the at least one ESD protection circuit correlates within a predetermined percentage of a final signoff tool analysis.

Although aspects of apparatuses and methods for use in fabricating or using ESD protection have been described in language specific to features and/or methods, the subject of the appended claims is not necessarily limited to the specific features or methods described. Rather, the specific features and methods are disclosed as example implementations of the techniques, and other equivalent features and methods are intended to be within the scope of the appended claims. Further, various aspects are described, and it is appreciated that each described aspect can be implemented independently or in connection with one or more other described aspects.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” may cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

What is claimed is:

1. A method for verifying electrostatic discharge (ESD) protection in an integrated circuit design, the method comprising:
receiving a layout of the integrated circuit design during an early design phase, the layout including at least one ESD protection circuit and not being required to be short-clean;
configuring a grid-based extraction tool to model an internal structure of the at least one ESD protection circuit from an upper metal layer down to a lower metal layer;
modeling layers of the integrated circuit design by modeling the internal structure of the at least one ESD protection circuit while excluding unrelated power grid geometries that do not impact ESD analysis;
analyzing a resistance, a current density, or both of the at least one ESD protection circuit using the configured grid-based extraction tool to identify violations within the internal structure; and
generating a verification report indicating whether the at least one ESD protection circuit meets a robustness threshold defined for the lower metal layer.

2. The method of claim 1, wherein the early design phase comprises a floor planning stage of the integrated circuit design.

3. The method of claim 1, wherein the lower metal layer comprises a lowest metal layer.

4. The method of claim 1, wherein the lower metal layer comprises a Metal 0 (M0) layer.

5. The method of claim 1, wherein the upper metal layer comprises a top metal layer.

6. The method of claim 1, wherein the upper metal layer comprises a Metal 13 (M13) or a Metal 14 (M14) layer.

7. The method of claim 1, wherein the robustness threshold defined for the lower metal layer is provided by a foundry.

8. The method of claim 1, wherein the grid-based extraction tool comprises a PathFinder-SC tool.

9. The method of claim 1, wherein selectively modeling layers comprises increasing modeling accuracy for layers within the at least one ESD protection circuit while reducing modeling of intermediate layers outside the at least one ESD protection circuit.

10. An apparatus for verifying electrostatic discharge (ESD) protection in an integrated circuit (IC) design, the apparatus comprising:
a memory storing a layout of the integrated circuit design, the layout including at least one ESD protection circuit; and
a processor coupled to the memory and configured to execute a grid-based extraction tool configured to:
model an internal structure of the at least one ESD protection circuit from an upper metal layer down to a lower metal layer during an early design phase, the layout of the IC design not required to be short-clean;
extract geometries by including layers of the internal structure of the at least one ESD protection circuit and excluding unrelated power grid geometries;
calculate resistance and current density through the internal structure of the at least one ESD protection circuit; and
verify the at least one ESD protection circuit against a robustness threshold associated with the lower metal layer.

11. The apparatus of claim 10, wherein the grid-based extraction tool is configured to perform analysis on the layout during a floor planning stage.

12. The apparatus of claim 10, wherein the processor is configured to model the internal structure from a top pin layer down to a substrate-level metal layer.

13. The apparatus of claim 10, wherein the lower metal layer comprises a lowest metal layer.

14. The apparatus of claim 10, wherein the lower metal layer comprises a Metal 0 (M0) layer.

15. The apparatus of claim 10, wherein the upper metal layer comprises a top metal layer.

16. The apparatus of claim 10, wherein the upper metal layer comprises a Metal 13 (M13) or a Metal 14 (M14) layer.

17. The apparatus of claim 10, wherein the robustness threshold is a foundry-provided threshold.

18. The apparatus of claim 10, wherein the robustness threshold is for a Metal 0 (M0) layer.

19. The apparatus of claim 10, wherein the processor is configured to abstract unrelated nets to reduce computational load on the grid-based extraction tool.

20. The apparatus of claim 10, wherein the verification of the at least one ESD protection circuit correlates within a predetermined percentage of a final signoff tool analysis.
